(19) United States
(12) Patent Application Publication
(10) Pub. No.: US 2026/0073882 A1
(43) Pub. Date: Mar. 12, 2026

(54) DISPLAY DEVICE

(71) Applicant: Tianma Advanced Display Technology Institute (Xiamen) Co., Ltd., Xiamen (CN)

(72) Inventor: Yingteng ZHAI, Xiamen (CN)

(21) Appl. No.: 19/389,098

(22) Filed: Nov. 14, 2025

(30) Foreign Application Priority Data
Jun. 25, 2025 (CN) 202510858941.7

(51) Int. Cl. G09G 3/34

(52) U.S. Cl. CPC G09G 3/3426; G09G 2320/0233; G09G 2320/0247; G09G 2320/0271; G09G 2320/066; G09G 2360/16

(57) ABSTRACT

Provided is a display device, including a display panel and a driving chip electrically connected thereto. A display region is provided with a plurality of pixel units, one of which includes n pixels, where n≥2. The driving chip drives the display panel to display according to grayscale information of the pixel unit in image data. A number of light-emitting pixels in the pixel unit during display is less than a number of pixels with non-zero grayscales in the grayscale information of the pixel unit. When grayscale information is a first grayscale, a number of light-emitting pixels in the pixel unit during display is n1, and brightness of at least one pixel is L1. When grayscale information is a second grayscale larger than the first grayscale, a number of light-emitting pixels in the pixel unit during display is n2>n1, and brightness of at least one pixel is L2>L1.

### CROSS-REFERENCE TO RELATED APPLICATIONS

The present application claims priority to Chinese Patent Application No. 202510858941.7 filed on June 25, 2025, the content of which is incorporated herein by reference in its entirety.

### TECHNICAL FIELD

The present disclosure relates to the field of display technologies, and in particular, to a display device.

### BACKGROUND

In the related art, a pixel circuit arranged in a display panel includes a pulse width modulation circuit and an amplitude modulation circuit. The pulse width modulation circuit is configured to control a duration of providing a driving current to a light-emitting device based on a first data voltage. The amplitude modulation circuit is configured to control an amplitude of providing a driving current to a light-emitting device based on a second data voltage. The pixel circuit can accurately regulate the light-emitting stage duration of the light-emitting device, thereby accurately controlling a grayscale displayed by the light-emitting device. However, due to the characteristics of the pixel circuit itself, the driving current decreases when driving to display a small grayscale, resulting in a small brightness at a small grayscale and affecting the display effect.

### SUMMARY

Embodiments of the present disclosure provide a display device to solve the issue of a small brightness at a small grayscale, thereby improving the display effect.

The display device provided by the embodiments of the present disclosure includes a display panel and a driving chip. The driving chip is electrically connected to the display panel; the display panel includes a display region provided with a plurality of pixel units, one pixel unit of the plurality of pixel units includes n pixels, where n is an integer and n≥2. The driving chip drives the display panel to display according to grayscale information of the pixel unit in image data, a number of light-emitting pixels in the pixel unit during display is less than p, where p is an integer and 1≤p≤n, and p is a number of pixels with a non-zero grayscale in the grayscale information of the pixel unit. When grayscale information of the pixel unit in the image data is a first grayscale, a number of light-emitting pixels in the pixel unit of the display panel during display is n1, and a brightness of at least one pixel is L1, where n1 is an integer and 1≤n1<n; and when grayscale information of the pixel unit in the image data is a second grayscale, a number of light-emitting pixels in the pixel unit of the display panel during display is n2, and a brightness of at least one pixel is L2, where n2 is a positive integer and n2<n. The first grayscale is smaller than the second grayscale, and n1<n2 and L1<L2.

### BRIEF DESCRIPTION OF DRAWINGS

In order to better illustrate the technical solutions in the embodiments of the present disclosure, the drawings used in the description of the embodiments or in the related art will be briefly illustrated as follows. It should be noted that, the drawings in the following description are merely some of, rather than all of the embodiments of the present disclosure. For those skilled in the art, other drawings can be obtained in accordance with these drawings without any creative efforts.

FIG. 1 is a schematic diagram of a display device according to an embodiment of the present disclosure;

FIG. 2 is a comparison diagram of a pixel unit in image data and a pixel unit during display rendering according to an embodiment of the present disclosure;

FIG. 3 is another comparison diagram of a pixel unit in image data and a pixel unit during display rendering according to an embodiment of the present disclosure;

FIG. 4A is a schematic diagram of module division of a driving chip according to an embodiment of the present disclosure;

FIG. 4B is a flowchart of a driving method of a display panel according to an embodiment of the present disclosure;

FIG. 5A is a schematic diagram of module division of another driving chip according to an embodiment of the present disclosure;

FIG. 5B is a flowchart of another driving method of a display panel according to an embodiment of the present disclosure;

FIG. 6 is another comparison diagram of a pixel unit in image data and a pixel unit during display rendering according to an embodiment of the present disclosure;

FIG. 7 is another comparison diagram of a pixel unit in image data and a pixel unit during display rendering according to an embodiment of the present disclosure;

FIG. 8 is a schematic diagram of a pixel unit for displaying a rendering graphic according to an embodiment of the present disclosure;

FIG. 9 is a comparison diagram of a pixel unit in another image data and a pixel unit during display rendering according to an embodiment of the present disclosure;

FIG. 10 is a schematic diagram of another pixel unit for displaying a rendering graphic according to an embodiment of the present disclosure;

FIG. 11 is another comparison diagram of a pixel unit in image data and a pixel unit during display rendering according to an embodiment of the present disclosure;

FIG. 12A is a schematic diagram of another pixel unit for displaying a rendering graphic according to an embodiment of the present disclosure;

FIG. 12B is a schematic diagram of another pixel unit for displaying a rendering graphic according to an embodiment of the present disclosure;

FIG. 13 is another comparison diagram of a pixel unit in image data and a pixel unit during display rendering according to an embodiment of the present disclosure;

FIG. 14 is another comparison diagram of a pixel unit in image data and a pixel unit during display rendering according to an embodiment of the present disclosure;

FIG. 15 is a schematic diagram of another pixel unit for displaying a rendering graphic according to an embodiment of the present disclosure;

FIG. 16 is a schematic diagram of another pixel unit for displaying a rendering graphic according to an embodiment of the present disclosure;

FIG. 17 is a schematic diagram of another pixel unit for displaying a rendering graphic according to an embodiment of the present disclosure;

FIG. 18 is a schematic diagram of another pixel unit for displaying a rendering graphic according to an embodiment of the present disclosure;

FIG. 19 is a schematic diagram of another pixel unit for displaying a rendering graphic according to an embodiment of the present disclosure;

FIG. 20 is a schematic diagram of another pixel unit for displaying a rendering graphic according to an embodiment of the present disclosure;

FIG. 21 is a schematic diagram of another pixel unit for displaying a rendering graphic according to an embodiment of the present disclosure;

FIG. 22 is a schematic diagram of another pixel unit for displaying a rendering graphic according to an embodiment of the present disclosure;

FIG. 23 is a schematic diagram of another pixel unit for displaying a rendering graphic according to an embodiment of the present disclosure; and

FIG. 24 is a schematic diagram of a pixel circuit according to an embodiment of the present disclosure.

### DESCRIPTION OF EMBODIMENTS

In order to more clearly illustrate objectives, technical solutions, and advantages of embodiments of the present disclosure, the technical solutions in embodiments of the present disclosure are described in details with reference to the drawings. It should be noted that, the embodiments described are only some rather than all of the embodiments of the present disclosure. Based on the embodiments of the present disclosure, all other embodiments obtained by those ordinary skilled in the art without creative efforts shall fall within a scope of the present disclosure.

Terms used in the embodiments of the present disclosure are only for the purpose of describing specific embodiments, but not intended to limit the present disclosure. Singular forms of “a/an”, “said” and “the” used in the embodiments of the present disclosure and the appended claims are also intended to include plural forms thereof, unless explicitly noted otherwise in the context.

Embodiments of the present disclosure provide a display device, in which the driving chip drives the display panel to display by reducing the number of actual light-emitting pixels in the pixel unit according to the grayscale information in the image data, and correspondingly sets the number of actual light-emitting pixels and the pixel brightness in the pixel unit during display by matching different grayscales of the pixel unit in the image data. By reducing the number of actual light-emitting pixels in the pixel unit for display, the brightness of a single light-emitting pixel can be increased, thereby increasing a driving current required by the light-emitting pixel. In addition, the number of actual light-emitting pixels and the pixel brightness in the pixel unit during display are correspondingly set by matching different grayscales of the pixel unit in the image data. Compared with a case that the display panel is directly driven by the pixel grayscale information in the image data, the pixels emit light at relatively large brightness during actual display, thereby avoiding the decrease of the driving current under a small brightness, alleviating the issue of a small brightness at a small grayscales, and thus improving the display effect. The above is the main technical idea of the present disclosure, and the technical idea of the present disclosure will be explained below in specific embodiments.

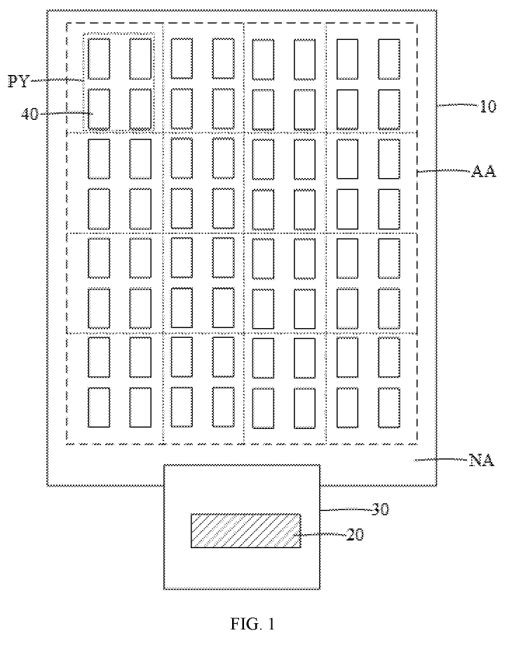

FIG. 1 is a schematic diagram of a display device according to an embodiment of the present disclosure. As shown in FIG. 1, the display device includes a display panel 10 and a driving chip 20 electrically connected to the display panel 10. FIG. 1 shows that the driving chip 20 is bound to a flexible circuit board 30. The flexible circuit board 30 is bound to the display panel 10, enabling the driving chip 20 to be electrically connected to the display panel 10. In some other embodiments, the driving chip 20 may be directly fixed in the non-display region NA of the display panel 10. In some other embodiments, signal terminals on a back side of the display panel may be connected by using side traces of the display panel, and then the driving chip 20 or the flexible circuit board 30 bound with the driving chip 20 is electrically connected to the signal terminals on the back side of the display panel. It can be understood that the display panel is provided with signal lines intersecting with each other and pixel circuits. The driving chip 20 provides signals to the signal lines in the display panel to drive the display panel to display an image.

As shown in FIG. 1, the display region AA of the display panel 10 includes a plurality of pixel units PY. One of the plurality of pixel units includes n pixels 40, where n is an integer and n≥2. FIG. 1 only illustrates n=4. In an embodiment of the present disclosure, n may be 6, 9, 16, or the like, and n pixels 40 in the pixel unit PY are arranged in regular rows and columns.

The driving chip 20 drives the display panel 10 to display according to grayscale information of the plurality of pixel units PY in the image data. A number of light-emitting pixels 40 in the pixel unit PY during display is less than p, where p is an integer and 1≤p≤n, and p is a number of pixels with a non-zero grayscale in the grayscale information of the pixel unit PY. That is, the driving chip 20 processes the image data and then provides a signal to the display panel 10. Compared with the number of pixels with the non-zero grayscale in the pixel unit PY in the image data, the number of light-emitting pixels in the pixel unit PY is less when the display panel actually performs display. That is, when the display panel actually displays, the number of light-emitting pixels in the pixel unit PY is reduced. The image data is data received by the driving chip 20, for example, the image data is data provided to the driving chip 20 by a screen driving board in the display device. The image data includes grayscale brightness information corresponding to each pixel 40 in one frame of the image.

The grayscale information of the pixel unit PY in the image data is a first grayscale. The first grayscale is a grayscale corresponding to the total brightness of n pixels in the pixel unit PY in the image data. When the display panel 10 displays, the number of light-emitting pixels in the pixel unit PY is n1, the brightness of at least one pixel is L1, the total brightness of pixels in the pixel unit PY is a brightness corresponding to the first grayscale, where n1 is a positive integer and 1≤n1<n. The grayscale information of the pixel unit PY in the image data is a second grayscale. The second grayscale is a grayscale corresponding to the total brightness of n pixels in the pixel unit PY in the image data. When the display panel 10 displays, the number of light-emitting pixels in the pixel unit PY is n2, the brightness of at least one pixel is L2, the total brightness of pixels in the pixel unit PY is a brightness corresponding to the second grayscale, where n2 is a positive integer and n2<n. The first grayscale is smaller than the second grayscale, where n1<n2 and L1<L2. If 1≤n1, n2≥2, that is, a minimum value of n2 is 2.

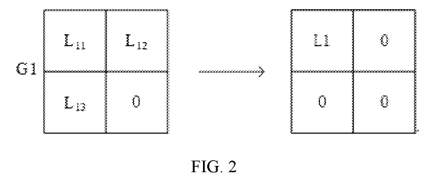

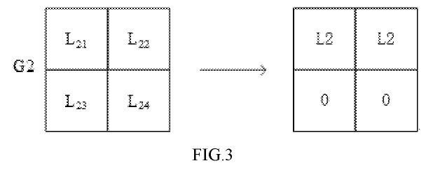

The relationship between the grayscale information of the pixel unit in the image data and the pixel brightness during display is described herein. The driving chip 20 processes the grayscale information of the pixel unit PY in the image data. Each pixel in the pixel unit PY corresponds to its respective grayscale information. In other words, each pixel in the image data has corresponding brightness information. The driving chip 20 processes the grayscale information in the image data to obtain a data voltage required for driving the pixel to display, and provides the data voltage to the display panel to drive the pixel to emit light, and the data voltage determines the light-emitting brightness of the pixel during display. The data voltage is a voltage written into the pixel circuit during the data writing phase of the pixel circuit’s operation. The data voltage affects the magnitude of the driving current generated by the pixel circuit, thereby affecting the light-emitting brightness of the pixel. For example, n=4. FIG. 2 is a comparison diagram of a pixel unit in image data and a pixel unit during display rendering according to an embodiment of the present disclosure. FIG. 3 is another comparison diagram of a pixel unit in image data and a pixel unit during display rendering according to an embodiment of the present disclosure. In both FIG. 2 and FIG. 3, the left graphic represents a graphic of the pixel unit PY in the image data, and the right graphic represents an actual display rendering graphic of the pixel unit PY. In the graphic of the pixel unit PY in the image data, 0 represents 0 grayscale, L represents the brightness corresponding to the grayscale of the pixel in the image pixel data, and 0 in the display rendering graphic represents that the pixel 40 does not emit light. The meaning of 0 in the following related drawings may also be understood with reference to the description herein.

In FIG. 2, grayscale information of the pixel unit PY in the image data is the first grayscale G1, three pixels in the pixel unit PY in the image data are non-zero grayscales, the brightness corresponding to the three non-zero grayscales are L₁₁, L₁₂ and L₁₃ respectively. A total brightness (i.e., after the brightness) of the three pixels is a brightness corresponding to the first grayscale G1. Corresponding to the first grayscale G1, when the display panel displays, one pixel 40 in the pixel unit PY emits light, and the brightness of the light-emitting pixel 40 is L1. That is, p=3, n1<p, and n1=1.

In FIG. 3, grayscale information of the pixel unit PY in the image data is the second grayscale G2, four pixels in the pixel unit PY in the image data are non-zero grayscales, the brightness corresponding to the four non-zero grayscales are L₂₁, L₂₂, L₂₃ and L₂₄ respectively. A total brightness of the four pixels is a brightness corresponding to the second grayscale G2. Corresponding to the second grayscale G2, when the display panel displays, two pixels 40 in the pixel unit PY emit light, and the brightness of the light-emitting pixel 40 is L2. That is, p=4, n2<p, and n2=2.

The first grayscale G1 is smaller than the second grayscale G2. That is, a sum of the brightness of L₁₁, L₁₂ and L₁₃ is smaller than a sum of the brightness of L₂₁, L₂₂, L₂₃ and L₂₄. And, n1<n2, L1<L2.

FIG. 3 shows that corresponding to the second grayscale G2, the brightness of each of two light-emitting pixels 40 in the display rendering graphic of the pixel unit PY is L2. When corresponding to the second grayscale G2 and n2≥2, the brightness of the actual light-emitting pixels in the pixel unit PY may be different, as long as the brightness of at least one pixel 40 is L2. The brightness of the light-emitting pixels 40 in the pixel unit PY during display may be different, which will be described in the following related embodiments.

In addition, compared with FIG. 2 and FIG. 3, the first grayscale G1 is smaller than the second grayscale G2. Corresponding to the first grayscale G1, the number of pixels with a non-zero grayscale in the grayscale information of the pixel unit PY in the image data is 3. Corresponding to the second grayscale G2, the number of pixels with a non-zero grayscale in the grayscale information of the pixel unit PY in the image data is 4. That is, as illustrated in FIGS. 2 and 3, the number of the pixels with a non-zero grayscale in the image data corresponding to the first grayscale G1 is less than that in the image data corresponding to the second grayscale G2. Generally, the larger the grayscale, the more the number of pixels with a non-zero grayscale in the image data, but this is not an absolute rule. In some cases, the first grayscale G1 is smaller than the second grayscale G2, n1<n2, L1<L2, the number of the pixels with a non-zero grayscale in the image data corresponding to the first grayscale G1 is equal to that in the image data corresponding to the second grayscale G2; or the number of the pixels with a non-zero grayscale in the image data corresponding to the first grayscale G1 is more than that in the image data corresponding to the second grayscale G2.

In the embodiments of the present disclosure, the driving chip 20 drives the display panel 10 to display by reducing the number of actual light-emitting pixels in the pixel unit PY according to the grayscale information in the image data, and correspondingly sets the number of actual light-emitting pixels and the pixel brightness in the pixel unit PY during display by matching different grayscales of the pixel unit PY in the image data. As the grayscale of the pixel unit in the image data increases, the number of actual light-emitting pixels 40 in the pixel unit PY during display increases, and the brightness of at least one of the actual light-emitting pixels also gradually increases. According to the present disclosure, display is performed by reducing the number of actual light-emitting pixels in the pixel unit PY. Compared with the situation that the display panel is directly driven by adopting the pixel grayscale information in the image data, the brightness of at least one light-emitting pixel 40 can be increased, thereby increasing the driving current required by the pixels 40, avoiding the decrease of the driving current under small brightness, alleviating the issue of a small brightness at a small grayscale, and thus improving the display effect.

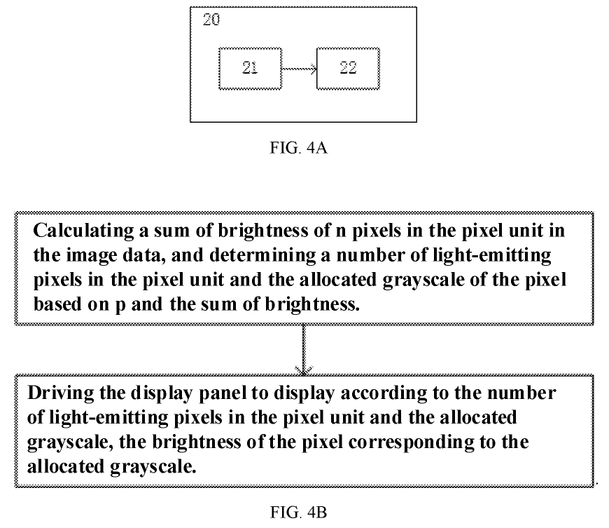

In some embodiments, FIG. 4A is a schematic diagram of module division of a driving chip according to an embodiment of the present disclosure. As shown in FIG. 4A, the driving chip 20 includes a brightness allocation module 21 and a display data module 22. FIG. 4B is a flowchart of a driving method of a display panel according to an embodiment of the present disclosure. The working flow of the driving chip 20 will be illustrated with reference to FIGS. 4A and 4B.

The brightness allocation module 21 in the driving chip 20 is configured to calculate a sum of the brightness of the n pixels 40 in the pixel unit PY in the image data, and determine a number of light-emitting pixels 40 in the pixel unit PY and the allocated grayscale of the pixel 40 based on p and the sum of the brightness. The brightness allocation module 21 calculates the brightness corresponding to each pixel according to the grayscale information corresponding to the pixel unit PY in the image data, and then calculates the sum of the brightness of the n pixels 40 in the pixel unit PY in the image data. After determining the number of light-emitting pixels, the sum of the brightness is evenly allocated to each pixel to determine the allocated grayscale of each pixel 40. Alternatively, after determining the number of the light-emitting pixels, the allocated grayscale of each pixel is not equal to each other, that is, the light-emitting pixels in the pixel unit PY have at least two brightnesses during display.

The display data module 22 in the driving chip 20 drives the display panel 10 to display according to the number of the light-emitting pixels 40 in the pixel unit PY and the allocated grayscales, and the brightness of the pixel 40 corresponds to the allocated grayscale during display. The data voltage is determined according to the allocated grayscale, and is provided to the display panel.

In an embodiment of the present disclosure, the driving chip 20 adds and calculates the brightness information corresponding to the received grayscale information of the pixel unit PY to obtain the sum of the brightness, and then determines the allocated grayscale of the pixel 40 in the pixel unit PY during display, thereby reducing the number of actual light-emitting pixels in the pixel unit PY according to the grayscale information in the image data to drive the display panel 10 to display.

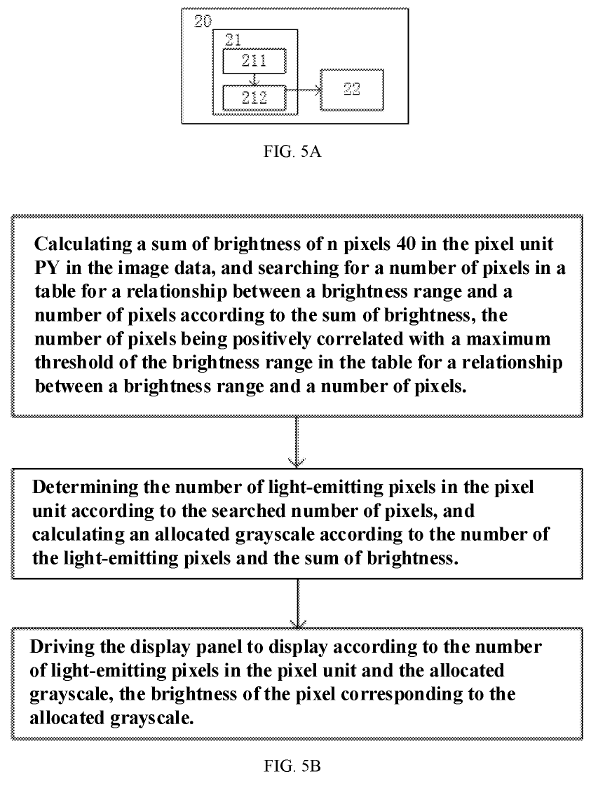

In some embodiments, FIG. 5A is a schematic diagram of module division of another driving chip according to an embodiment of the present disclosure. As shown in FIG. 5A, the driving chip 20 includes a brightness allocation module 21 and a display data module 22. The brightness allocation module 21 includes a searching sub-module 211 and a data generation sub-module 212. FIG. 5B is a flowchart of another driving method of a display panel according to an embodiment of the present disclosure. The working flow of the driving chip 20 will be illustrated with reference to FIGS. 5A and 5B.

The searching sub-module 211 in the brightness allocation module 21 is configured to calculate the sum of the brightness of the n pixels 40 in the pixel unit PY in the image data, and search for the number of pixels in a table for a relationship between a brightness range and a number of pixels according to the sum of the brightness. The number of pixels is positively correlated with a maximum threshold of the brightness range in the table for a relationship between a brightness range and a number of pixels.

The data generating sub-module 212 in the brightness allocation module 21 is configured to determine the number of the light-emitting pixels in the pixel unit PY according to the searched number of pixels and calculate the allocated grayscale according to the number of the light-emitting pixels and the sum of the brightness of the n pixels 40 in the pixel unit PY in the image data.

The display data module 22 drives the display panel 10 to display according to the number of the light-emitting pixels 40 in the pixel unit PY and the allocated grayscale thereof, and the brightness of the pixel 40 corresponds to the allocated grayscale during display.

In an embodiment of the present disclosure, the table for a relationship between a brightness range and a number of pixels is provided in the driving chip 20. After calculating the sum of the brightness corresponding to the pixel unit PY in the image data, the number of the light-emitting pixels in the pixel unit PY during display is determined according to the table for a relationship between a brightness range and a number of pixels, and then the allocated grayscale of the pixel during display is calculated according to the number of the light-emitting pixels and the sum of the brightness of the n pixels 40 in the pixel unit PY in the image data.

In some embodiments, when grayscale information of the pixel units PY in the image data is a third grayscale, a number of the light-emitting pixels in the pixel unit PY of the display panel during display is n3, and a brightness of at least one of the pixels is L3. The third grayscale is smaller than the first grayscale, where n3=n1 and L3<L1.

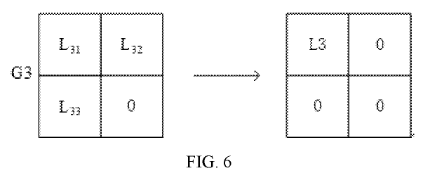

FIG. 6 is another comparison diagram of a pixel unit in image data and a pixel unit during display rendering according to an embodiment of the present disclosure. Continuing with the examples in FIG. 2 and FIG. 3, n1=n3=1 is taken as an example. In FIG. 6, when the grayscale information of the pixel unit PY in the image data is a third grayscale G3, three pixels in the pixel unit PY in the image data are non-zero grayscales, and the brightness corresponding to each of the three non-zero grayscales is L₃₁, L₃₂ and L₃₃ respectively. A total brightness of the three pixels is a brightness corresponding to the third grayscale G3. Corresponding to the third grayscale G3, when the display panel displays, one pixel 40 in the pixel unit PY emits light, and the brightness of the light-emitting pixel 40 is L3. That is, p=3, n3<p, n3=n1=1, and L3<L1.

Compared with the first grayscale G1 shown in FIG. 2 and the third grayscale G3 shown in FIG. 6, within a certain grayscale range, as the grayscale corresponding to the pixel unit PY in the image data is increased, the number of the light-emitting pixels 40 in the pixel unit PY does not change and the brightness of at least one of the light-emitting pixels 40 increases when the display panel displays. For example, when the grayscale information of the pixel unit PY in the image data is smaller than the third grayscale, the number of light-emitting pixels in the pixel unit PY during display is n3, and the brightness of at least one pixel is smaller than L3.

Referring to FIG. 2, FIG. 3 and FIG. 6, the grayscale values of the third grayscale G3, the first grayscale G1 and the second grayscale G2 are gradually increased, n3=n1<n2 and L3<L2. That is, in some embodiments of the present disclosure, with the increase of the grayscale of the pixel unit PY in the image data, the brightness of at least one of the light-emitting pixels is first increased without changing the number of the light-emitting pixels to increase the grayscale displayed by the pixel unit PY, and then the grayscale displayed by the pixel unit PY is continuously increased by increasing the brightness of at least one of the light-emitting pixels and increasing the number of the light-emitting pixels.

In some embodiments of the present disclosure, n1=1. That is, the grayscale information of the pixel unit PY in the image data is the third grayscale G3 and/or the first grayscale G1. When the display panel actually displays, the number of light-emitting pixels in the pixel unit PY is 1. When the grayscale information of the pixel unit PY in the image data is a relatively small grayscale, the display panel 10 is driven to display by reducing the number of actual light-emitting pixels in the pixel unit PY according to the grayscale information in the image data, and the number of actual light-emitting pixels in the pixel unit PY during display is configured to be 1. That is, one pixel 40 is configured to emit light to display grayscale information corresponding to two or more pixels in the original image data. By adopting one pixel to emit light, it does not need to share brightness with other pixels, so that the brightness of a single pixel 40 can be relatively large, and the driving current corresponding to the pixel 40 is relatively large, thereby avoiding the issue of decreasing the driving current at a small brightness, alleviating the issue of a small brightness at a small grayscale, and thus improving the display effect.

In some embodiments, when the display panel 10 displays, the number of the light-emitting pixels 40 in at least one pixel unit PY is more than 1, and the brightness of each of at least two light-emitting pixels 40 in the pixel unit PY is different from each other. Such a configuration can meet the display requirement when the pixel unit PY in the image data corresponds to different grayscale information, so that the display can be performed by reducing the number of actual light-emitting pixels in the pixel unit PY when different grayscale information is performed. Moreover, as the grayscale corresponding to the pixel unit PY in the image data is increased, the number of actual light-emitting pixels 40 in the pixel unit PY during display is gradually increased, and the brightness of at least one of the light-emitting pixels is also gradually increased.

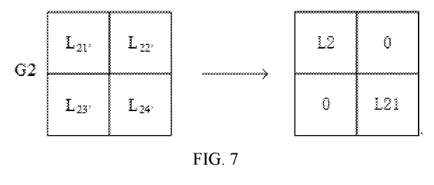

FIG. 7 is another comparison diagram of a pixel unit in image data and a pixel unit during display rendering according to an embodiment of the present disclosure. FIG. 7 illustrates a display rendering graphic in which the total brightness of the pixel unit corresponds to the second grayscale G2, where n2≥2, and n2=2 is taken as an example. As shown in FIG. 7, the grayscale information of the pixel unit PY in the image data is the second grayscale G2. When the display panel 10 displays, the number of the light-emitting pixels 40 in the pixel unit PY is n2, and the brightness of at least one pixel 40 is L2; and the pixel unit PY further includes at least one pixel 40 with a light-emitting brightness of L₂₁, where L₂₁<L1. Four pixels in the pixel unit PY in the image data are non-zero grayscales, the brightness corresponding to each of the four non-zero grayscales is L_{21’}, L_{22’}, L_{23’} and L_{24’} respectively. A total brightness of the four pixels 40 is a brightness corresponding to the second grayscale G2.

The second grayscale G2 shown in FIG. 7 is larger than the first grayscale G1 shown in FIG. 2, and the second grayscale G2 shown in FIG. 7 is smaller than the second grayscale G2 shown in FIG. 3. That is, when the grayscale corresponding to the grayscale information of the pixel unit PY in the image data is between the first grayscale G1 shown in FIG. 2 and the second grayscale G2 shown in FIG. 3, the number of actual light-emitting pixels in the pixel unit PY of the display panel during display is n2. The brightness of at least one actual light-emitting pixel is larger than the brightness of the actual light-emitting pixel corresponding to the first grayscale G1, and the brightness of at least one actual light-emitting pixel is smaller than the brightness of the actual light-emitting pixel corresponding to the first grayscale G1. By configuring the brightness of each of at least two light-emitting pixels 40 in the pixel unit PY to be different from each other during display of the display panel, display requirements of some transition grayscales between the first grayscale G1 illustrated in FIG. 2 and the second grayscale G2 illustrated in FIG. 3 can be satisfied.

In some embodiments, n1=1, n2=2. When corresponding to the relatively small grayscale of the pixel unit PY in the image data, one pixel 40 is used to emit light during display, thereby increasing the brightness of the pixel 40 and avoiding the issue of decreasing driving current at a small brightness. When corresponding to a relatively large grayscale of the pixel unit PY in the image data, two pixels 40 are configured to emit light during display, and the light-emitting brightness of at least one pixel is larger than the light-emitting brightness of the pixel 40 with a relatively small grayscale. On the one hand, it avoids the problem of a decrease in driving current at a small brightness. On the other hand, when two or more pixels in the pixel unit PY emit light, it can also make the brightness of a region of the pixel unit PY more uniform, resulting in a better visual effect.

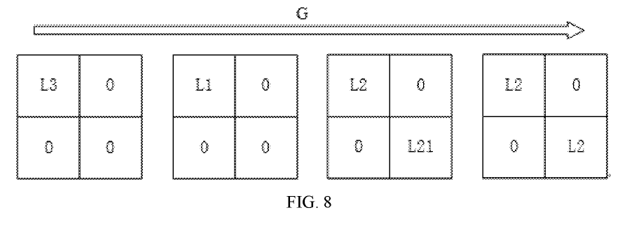

FIG. 8 is a schematic diagram of a pixel unit for displaying a rendering graphic according to an embodiment of the present disclosure. FIG. 8 illustrates a display rendering graphic corresponding to grayscales from small to large, and the arrow illustrates changes of grayscales G from small to large. Where L3<L1<L2, L₂₁<L1. It can be seen from FIG. 8 that, in an embodiment of the present disclosure, when the display panel is driven to display, with the increase of the grayscale of the pixel unit PY in the image data, the brightness of at least one of the light-emitting pixels is first increased without changing the number of the light-emitting pixels to increase the grayscale displayed by the pixel unit PY, and then the brightness of at least one of the light-emitting pixels is increased and the number of the light-emitting pixels is increased to continue to increase the grayscale displayed by the pixel unit PY, and then the number of the light-emitting pixels is increased and the brightness of all the light-emitting pixels is increased when displaying a relatively larger grayscale.

In some embodiments, when the display panel 10 displays, the number of the light-emitting pixels 40 in at least one pixel unit PY is more than 1, and the brightness of each of the light-emitting pixels 40 in the pixel unit PY is the same. The grayscale information of the pixel unit PY in the image data shown in FIG. 3 is the second grayscale G2. When the display panel displays, two pixels 40 in the pixel unit PY emit light, and the brightness of each of the two light-emitting pixels 40 is L2, respectively. In this embodiment, the number of actual light-emitting pixels in the pixel unit PY is reduced according to the grayscale information in the image data, the grayscale information is evenly allocated to the actual light-emitting pixels, and then the display panel 10 is driven to display. The calculation process of the grayscale allocation is relatively simple, and the brightness of each light-emitting pixel is the same, resulting in better brightness uniformity in the pixel unit PY.

In some embodiments, a grayscale information of the pixel unit PY in the image data is a fourth grayscale, when the display panel 10 displays, a number of the light-emitting pixels 40 in the pixel unit PY is n4, and the brightness of each of the light-emitting pixels 40 is L4. The fourth grayscale is larger than the first grayscale and smaller than the second grayscale, where n4=n2 and L4<L1.

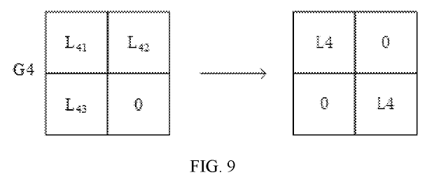

For example, n4=n2=2. FIG. 9 is a comparison diagram of a pixel unit in another image data and a pixel unit during display rendering according to an embodiment of the present disclosure. In FIG. 9, when the grayscale information of the pixel unit PY in the image data is a fourth grayscale G4, three pixels in the pixel unit PY in the image data are non-zero grayscales, and the brightness corresponding to each of the three non-zero grayscales is L₄₁, L₄₂ and L₄₃ respectively. A total brightness of the three pixels is a brightness corresponding to the fourth grayscale G4. Corresponding to the fourth grayscale G4, when the display panel displays, two pixels 40 in the pixel unit PY emit light, and the brightness of each of the two light-emitting pixel 40 is L4. That is, p=3, n4<p, n4=2. The fourth grayscale G4 illustrated in FIG. 9 is larger than the first grayscale G1 illustrated in FIG. 2 and smaller than the second grayscale G2 illustrated in FIG. 3. Where n1<n4=n2, L4<L2, and L4<L1.

The fourth grayscale G4 illustrated in FIG. 9 is between the first grayscale G1 illustrated in FIG. 2 and the second grayscale G2 illustrated in FIG. 3. The grayscale information of the pixel unit PY in the image data is the fourth grayscale G4, the number of actual light-emitting pixels in the pixel unit PY when the display panel displays is n4=n2, where n2≥2. The brightness of each of the actual light-emitting pixels in the pixel unit PY is the same. The brightness of each of the actual light-emitting pixels in the pixel unit PY is the same, and the light-emitting brightness is smaller than L1 (the brightness of the actual light-emitting pixel corresponding to the first grayscale G1). Such a configuration can meet display requirements of some transition grayscales between the first grayscale G1 shown in FIG. 2 and the second grayscale G2 shown in FIG. 3.

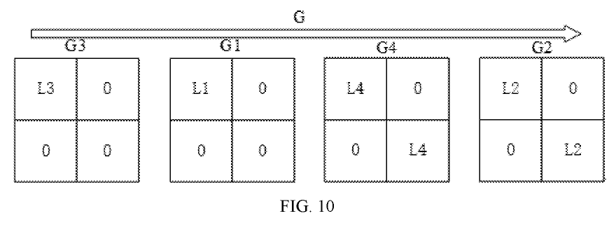

FIG. 10 is a schematic diagram of another pixel unit for displaying a rendering graphic according to an embodiment of the present disclosure. FIG. 10 illustrates a display rendering graphic corresponding to grayscales from small to large, and the arrow illustrates changes of grayscales G from small to large. Where L3<L1<L2, and L4<L1. FIG. 10 shows that the third grayscale G3, the first grayscale G1, the fourth grayscale G4, and the second grayscale G2 gradually increase. It can be seen from FIG. 10 that, in an embodiment of the present disclosure, when the display panel is driven to display, as the grayscale corresponding to the pixel unit PY in the image data is increased, the number of the light-emitting pixels 40 in the pixel unit PY gradually increases when the display panel 10 displays. When corresponding to a relatively large grayscale, for example, the fourth grayscale G4, the brightness of each of the light-emitting pixels 40 in the pixel unit PY during display is the same and smaller than the brightness of the light-emitting pixel 40 corresponding to the first grayscale G1. When corresponding to a relatively large grayscale, for example, the second grayscale G2, the brightness of each of the light-emitting pixels 40 in the pixel unit PY during display is the same and larger than the brightness of the light-emitting pixel 40 corresponding to the first grayscale G1.

In some embodiments, the grayscale information of the pixel unit PY in the image data is a fifth grayscale, when the display panel 10 displays, a number of the pixels 40 emitting light in the pixel unit PY is n5, and the brightness of at least one pixel 40 is L5. The second grayscale is smaller than the fifth grayscale, where n2<n5 and/or L2<L5.

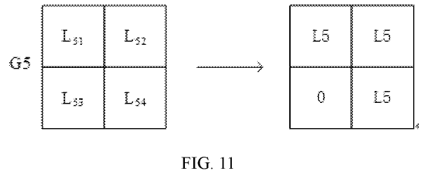

FIG. 11 is another comparison diagram of a pixel unit in image data and a pixel unit during display rendering according to an embodiment of the present disclosure. In FIG. 11, the grayscale information of the pixel unit PY in the image data is the fifth grayscale G5, four pixels in the pixel unit PY in the image data are non-zero grayscales, the brightness corresponding to each of the four non-zero grayscales is L₅₁, L₅₂, L₅₃ and L₅₄ respectively. A total brightness of the four pixels is a brightness corresponding to the fifth grayscale G5. Corresponding to the fifth grayscale G5, when the display panel displays, three pixels 40 in the pixel unit PY emit light, and the brightness of each of the three light-emitting pixels 40 is L5. That is, p=4 and n5=3<p.

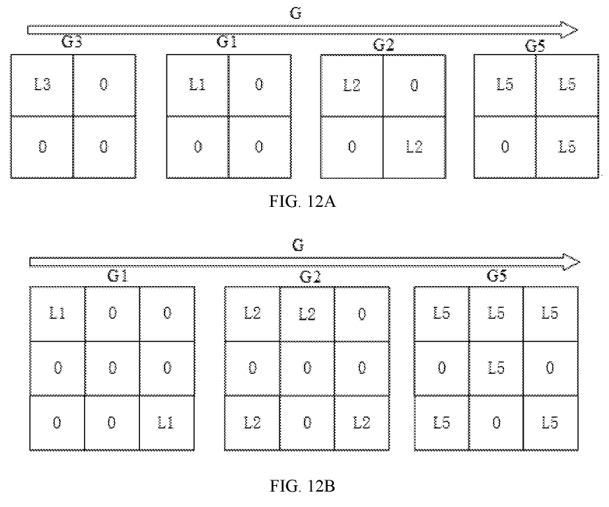

FIG. 12A is a schematic diagram of another pixel unit for displaying a rendering graphic according to an embodiment of the present disclosure. FIG. 12A illustrates a display rendering graphic corresponding to grayscales from small to large, and the arrow illustrates changes of grayscales G from small to large. FIG. 12A shows that the third grayscale G3, the first grayscale G1, the second grayscale G2, and the fifth grayscale G5 gradually increase. Where n3=n1<n2<n5, and L3<L1<L2<L5. It can be seen from FIG. 12A that, in an embodiment of the present disclosure, when the display panel is driven to display, when displaying a relatively small grayscale, for example, the third grayscale G3 and the first grayscale G1, the brightness of at least one of the light-emitting pixels is increased without changing the number of the light-emitting pixels to increase the grayscale displayed by the pixel unit PY. With the increase of the grayscale corresponding to the pixel unit PY in the image data, for example, the first grayscale G1, the second grayscale G2 and the fifth grayscale G5, the number of the light-emitting pixels 40 in the pixel unit PY gradually increases and the brightness of at least one of the light-emitting pixels 40 gradually increases when the display panel 10 displays.

In some other embodiments, n=9 is used as an example. FIG. 12B is a schematic diagram of another pixel unit for displaying a rendering graphic according to an embodiment of the present disclosure. FIG. 12B illustrates a display rendering graphic corresponding to grayscales from small to large, and the arrow illustrates changes of grayscales G from small to large. FIG. 12B shows that the first grayscale G1, the second grayscale G2, and the fifth grayscale G5 gradually increase. When the pixel unit PY displays the brightness corresponding to the first grayscale G1, there are 2 light-emitting pixels (n1=2) with light-emitting brightness of L1. When the pixel unit PY displays the brightness corresponding to the second grayscale G2, there are 4 light-emitting pixels (n2=4) with light-emitting brightness of L2. When the pixel unit PY displays the brightness corresponding to the fifth grayscale G5, there are 6 light-emitting pixels (n5=6) with light-emitting brightness of L5. Where n1<n2<n5 and L1<L2<L5. With the increase of the grayscale corresponding to the pixel unit PY in the image data, the number of the light-emitting pixels 40 in the pixel unit PY gradually increases when the display panel 10 displays, and the light-emitting brightness of at least one of the light-emitting pixels 40 gradually increases.

In the embodiment of FIG. 12A, the grayscale information of the pixel unit PY in the image data is the second grayscale G2, and the brightness of each of the light-emitting pixels in the pixel unit PY is the same when the display panel 10 displays. The grayscale information of the pixel unit PY in the image data is the fifth grayscale G5, and the brightness of each of the light-emitting pixels in the pixel unit PY is the same when the display panel 10 displays. That is, when the display panel 10 displays, the number of the light-emitting pixels 40 in the pixel unit PY is more than 1, and the brightness of each of the light-emitting pixels 40 in the pixel unit PY is the same.

In another embodiment, the grayscale information of the pixel unit PY in the image data is a fifth grayscale, when the display panel 10 displays, a number of the pixels 40 emitting light in the pixel unit PY is n5, and the brightness of at least one pixel 40 is L5. The second grayscale is smaller than the fifth grayscale; n2<n5 and L2=L5. The fifth grayscale in this embodiment is larger than the second grayscale G2 and smaller than the fifth grayscale G5 shown in FIG. 11. Such a configuration can meet display requirements of some transition grayscales between the second grayscale G2 shown in FIG. 2 and the fifth grayscale G5 shown in FIG. 11.

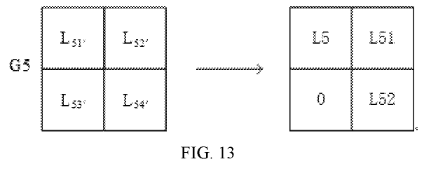

In FIG. 11, corresponding to the fifth grayscale G5, when the display panel displays, three pixels 40 in the pixel unit PY emit light, and the brightness of each of the three light-emitting pixels 40 is the same. In another embodiment, FIG. 13 is another comparison diagram of a pixel unit in image data and a pixel unit during display rendering according to an embodiment of the present disclosure. In FIG. 13, the grayscale information of the pixel unit PY in the image data is the fifth grayscale G5, four pixels in the pixel unit PY in the image data are non-zero grayscales, the brightness corresponding to each of the four non-zero grayscales is L_{51’}, L_{52’}, L_{53’} and L_{54’} respectively. A total brightness of the four pixels is a brightness corresponding to the fifth grayscale G5. Corresponding to the fifth grayscale G5, when the display panel displays, three pixels 40 in the pixel unit PY emit light, and the brightness of each of the three light-emitting pixel 40 is L5, L51, L52, respectively. That is, p=4, n5=3<p, n2<n5, L2<L5, and at least one of L51 and L52 is smaller than L2. The fifth grayscale G5 shown in FIG. 13 is larger than the second grayscale and smaller than the fifth grayscale G5 shown in FIG. 11. Such a configuration can meet display requirements of some transition grayscales between the second grayscale G2 shown in FIG. 2 and the fifth grayscale G5 shown in FIG. 11.

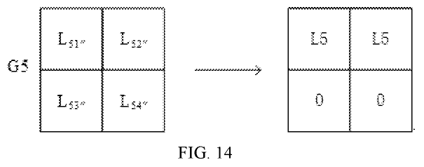

In some other embodiments, FIG. 14 is another comparison diagram of a pixel unit in image data and a pixel unit during display rendering according to an embodiment of the present disclosure. In FIG. 14, the grayscale information of the pixel unit PY in the image data is the fifth grayscale G5, four pixels in the pixel unit PY in the image data are non-zero grayscales, the brightness corresponding to each of the four non-zero grayscales is L_{51’’}, L_{52’’}, L_{53’’} and L_{54’’} respectively. A total brightness of the four pixels is a brightness corresponding to the fifth grayscale G5. Corresponding to the fifth grayscale G5, when the display panel displays, two pixels 40 in the pixel unit PY emit light, and the brightness of the light-emitting pixel 40 is L5. That is, p=4 and n5=2<p. Where N5=n2, L2<L5, making the fifth grayscale G5 larger than the second grayscale G2.

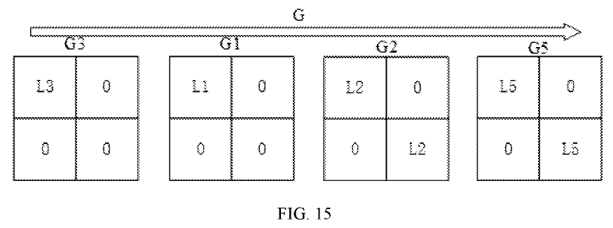

FIG. 15 is a schematic diagram of another pixel unit for displaying a rendering graphic according to an embodiment of the present disclosure. FIG. 15 illustrates a display rendering graphic corresponding to grayscales from small to large, and the arrow illustrates changes of grayscales G from small to large. FIG. 15 shows that the third grayscale G3, the first grayscale G1, the second grayscale G2, and the fifth grayscale G5 gradually increase. Where n3=n1<n2=n5, and L3<L1<L2<L5. It can be seen from FIG. 15 that, in an embodiment of the present disclosure, when the display panel is driven to display, when displaying a relatively small grayscale, for example, the third grayscale G3 and the first grayscale G1, the brightness of at least one of the light-emitting pixels is increased without changing the number of the light-emitting pixels to increase the grayscale displayed by the pixel unit PY. With the increase of the grayscale corresponding to the pixel unit PY in the image data, for example, the first grayscale G1, the second grayscale G2 and the fifth grayscale G5, the number of the light-emitting pixels 40 in the pixel unit PY gradually increases and the brightness of the light-emitting pixel 40 gradually increases when the display panel 10 displays.

FIG. 11, FIG. 13 and FIG. 14 illustrate examples of an optional display rendering graphic of the fifth grayscale G5 according to some embodiments of the present disclosure. With reference to the description of the embodiments in terms of the first grayscale G1 and the second grayscale G2, in the embodiment including the first grayscale G1, the second grayscale G2, and the fifth grayscale G5, the grayscale values of the first grayscale G1, the second grayscale G2, and the fifth grayscale G5 gradually increase, and satisfy the following relationship: n1<n2<n5 and/or L1<L2<L5.

In some embodiments, n2-n1=1 and n5-n2=1. In an embodiment of the present disclosure, with the increase of the grayscale corresponding to the pixel unit PY in the image data, the number of the light-emitting pixels 40 in the pixel unit PY gradually increases when the display panel displays, and the number of the light-emitting pixels is configured to increase with 1 as a step. When different grayscales of the pixel unit PY in the image data are matched to correspondingly set the number of actual light-emitting pixels and the pixel brightness in the pixel unit PY during display, the number of actual light-emitting pixels can be reduced as much as possible, the brightness of the light-emitting pixel 40 is ensured to be as large as possible, thereby avoiding the decrease of the driving current at a small brightness, alleviating the issue of a small brightness at a small grayscale, thus improving the display effect.

In some embodiments, the pixel unit PY includes a first pixel unit and a second pixel unit. The driving chip 20 drives the first pixel unit to display according to the grayscale information of the first pixel unit in the image data, and drives the second pixel unit to display according to the grayscale information of the second pixel unit. The grayscale information of the first pixel unit and the grayscale information of the second pixel unit in the image data are the same. When the display panel 10 displays, the number of light-emitting pixel(s) in the first pixel unit and the number of light-emitting pixel(s) in the second pixel unit are the same, and the brightness of the pixel(s) in the first pixel unit and the brightness of the pixel(s) in the second pixel unit are the same. In this embodiment, the grayscale information of the first pixel unit and the grayscale information of the second pixel unit in the image data being the same refers to that, the grayscale values corresponding to the grayscale information are the same. For example, when the display panel displays a single grayscale uniform image, the number of the actual light-emitting pixel(s) 40 in each pixel unit PY in the display panel is the same, and the brightness of the actual light-emitting pixel(s) 40 in each pixel unit PY is the same.

In some embodiments, the driving chip 20 drives the display panel 10 to display a plurality of consecutive frames. In at least one pixel unit PY, at least one light-emitting pixel 40 corresponds to different positions in two adjacent frames. Such a configuration can balance the light-emitting time of each pixel 40 in the pixel unit PY, thereby balancing the service life of each pixel 40 relatively and avoiding uneven display caused by different service life attenuation of each pixel 40 in the pixel unit PY.

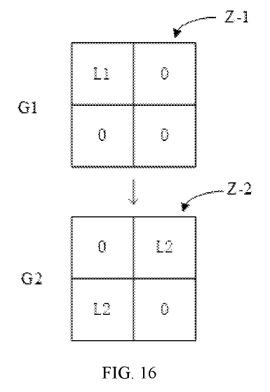

FIG. 16 is a schematic diagram of another pixel unit for displaying a rendering graphic according to an embodiment of the present disclosure. Taking n=4 as an example, four pixels 40 in the pixel unit PY are arranged in a 2*2 array, and the four pixels 40 correspond to respective position coordinates of 40 (i, j), where i represents the number of the row of the pixel 40 in the array, and j represents the number of the column of the pixel 40 in the array. FIG. 16 illustrates that the same pixel unit PY on the display panel displays rendering graphics in two adjacent frames Z-1 and Z-2. In the frame Z-1, the pixel unit PY displays a rendering graphic corresponding to the first grayscale G1, the number of the light-emitting pixels n1=1, the brightness of the light-emitting pixel is L1, and the coordinate corresponding to the light-emitting pixel is 40 (1, 1). In the frame Z-2, the pixel unit PY displays a rendering graphic corresponding to the second grayscale G2, the number of the light-emitting pixels n2=2, the brightness of the light-emitting pixel is L2, and the pixel coordinates corresponding to the light-emitting pixels are 40 (1, 2) and 40 (2, 1).

FIG. 16 illustrates that the same pixel unit PY emits light in two adjacent frames to display different grayscales. In some other embodiments, a same pixel unit PY emits light to display a same grayscale in two adjacent frames, and at least one light-emitting pixel 40 in the pixel unit PY corresponds to different positions in the two adjacent frames.

In some embodiments, n=4, for at least one pixel unit PY, two pixels 40 located at diagonal positions of the pixel unit PY emit light in each of two adjacent frames, and the two pixels 40 correspond to two different positions in the two adjacent frames. Such a configuration can enable the pixel unit PY to change the position of the light-emitting pixel in two adjacent frames, thereby balancing the service life of each pixel 40 in the pixel unit PY relatively and avoiding uneven display caused by different service life attenuation of each pixel 40 in the pixel unit PY. Moreover, the brightness in the region of the pixel unit PY is more uniform during display.

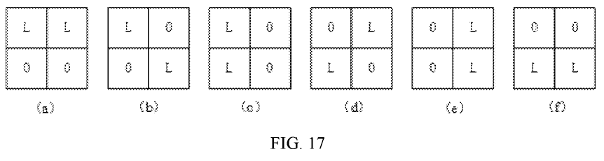

FIG. 17 is a schematic diagram of another pixel unit for displaying a rendering graphic according to an embodiment of the present disclosure. FIG. 17 illustrates n=4 and a display rendering graphic in which two pixels 40 emit light when the pixel unit PY actually displays. Four pixels 40 in the pixel unit PY are arranged in a 2*2 array, and the four pixels 40 correspond to respective position coordinates of 40 (i, j), where i represents the number of the row of the pixel 40 in the array, and j represents the number of the column of the pixel 40 in the array. L represents that the pixel emits light and does not represent a specific brightness, and 0 represents that the pixel does not emit light. FIG. 17 illustrates a total of six rendering graphics: (a), (b), (c), (d), (e), and (f). The coordinates of the light-emitting pixels in the graphic (b) are 40 (1, 1) and 40 (2, 2), and the coordinates of the light-emitting pixels in the graphic (d) are 40 (1, 2) and 40 (2, 1).

For example, when the pixel unit PY includes two light-emitting pixels 40 in each of two adjacent frames, the rendering graphic of the pixel unit PY in the first frame of the two adjacent frames is configured as FIG. 17 (b), and the rendering graphic of the pixel unit PY in the second frame is configured as FIG. 17 (d). In this case, a same pixel unit PY emits light by using different pixels in two adjacent frames, which can balance the service life of each pixel 40 in the pixel unit PY, and can make the brightness in the region of the pixel unit PY more uniform during display.

In some embodiments, the pixel unit PY has n light-emitting modes. When the display panel 10 displays, only one pixel 40 in the pixel unit PY emits light, and the light-emitting pixel 40 in the pixel unit PY corresponds to different positions in the n light-emitting modes. The driving chip 20 driving the display panel 10 to display a plurality of consecutive frames includes: the pixel unit PY sequentially performing n light-emitting modes in a plurality of consecutive frames.

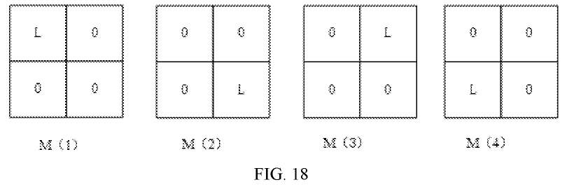

Taking n=4 as an example, the light-emitting mode of the pixel unit PY will be described. FIG. 18 is a schematic diagram of another pixel unit for displaying a rendering graphic according to an embodiment of the present disclosure. Taking n=4 as an example in FIG. 18, the pixel unit PY has 4 light-emitting modes. FIG. 18 illustrates that the display rendering graphics of the pixel unit PY in four light-emitting modes are M(1), M(2), M(3), and M(4) when only one pixel 40 in the pixel unit PY emits light. L indicates that the pixel emits light, and 0 indicates that the pixel does not emit light. When the pixel unit PY sequentially performs n light-emitting modes in a plurality of consecutive frames and one pixel 40 in the pixel unit PY emits light, it can realize that at least one light-emitting pixel 40 in the pixel unit PY corresponds to different positions in two adjacent frames.

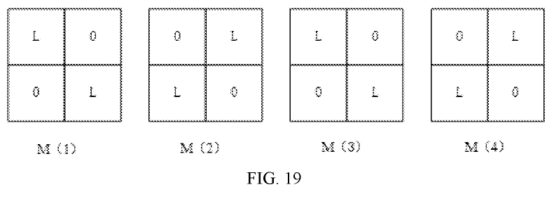

FIG. 19 is a schematic diagram of another pixel unit for displaying a rendering graphic according to an embodiment of the present disclosure. FIG. 19 illustrates the display rendering graphics of the pixel unit PY in four light-emitting modes are M(1), M(2), M(3), and M(4) when two pixels 40 in the pixel unit PY emit light, and n=4. The display rendering graphics of the light-emitting modes M (1) and M (3) are the same, and the display rendering graphics of the light-emitting modes M (2) and M (4) are the same. In different light-emitting modes of the display rendering graphic, the position coordinates of the light-emitting pixels are different. When the pixel unit PY sequentially performs n light-emitting modes in a plurality of consecutive frames and two pixels 40 in the pixel unit PY emit light, it can realize that at least one light-emitting pixel 40 in the pixel unit PY corresponds to different positions in two adjacent frames.

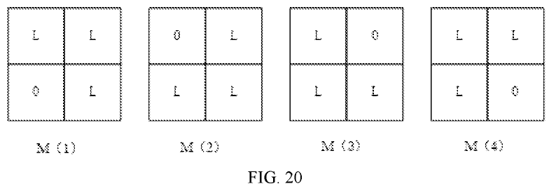

FIG. 20 is a schematic diagram of another pixel unit for displaying a rendering graphic according to an embodiment of the present disclosure. FIG. 20 illustrates the display rendering graphics of the pixel unit PY in four light-emitting modes are M(1), M(2), M(3), and M(4) when three pixels 40 in the pixel unit PY emit light, and n=4. It can be seen from FIG. 20 that, in two light-emitting modes in which display rendering graphics are different, position coordinates of two light-emitting pixels are the same and a position coordinate of one light-emitting pixel is different. When the pixel unit PY sequentially performs n light-emitting modes in a plurality of consecutive frames and three pixels 40 in the pixel unit PY emit light, it can realize that at least one light-emitting pixel 40 in the pixel unit PY corresponds to different positions in two adjacent frames.

In some embodiments, the pixel unit PY has n light-emitting modes. When the display panel 10 displays, only one pixel 40 in the pixel unit PY emits light, and the light-emitting pixel 40 in the pixel unit PY corresponds to different positions in the n light-emitting modes. When n=4, the display rendering graphics of the pixel unit PY in the 4 light-emitting modes may be understood with reference to FIG. 18 to FIG. 20.

The display panel 10 has a first working mode in which the driving chip 20 receives a plurality of groups of same image data. The same image data refers to that the grayscale information of the pixel at a same position in the image data is the same, i.e., a same image. The first working mode is equivalent to a working mode in which the display panel displays a static image. The driving chip 20 driving the display panel 10 to work in the first working mode includes: the pixel unit PY sequentially performing n light-emitting modes in a plurality of consecutive frames. Such a configuration can make the service life of each pixel 40 in the pixel unit PY relatively balanced, thereby avoiding uneven display caused by different service life attenuation of each pixel 40 in the pixel unit PY. Moreover, in each frame, the pixel unit PY uses different rendering graphics, reducing the display granularity at the expense of flicker.

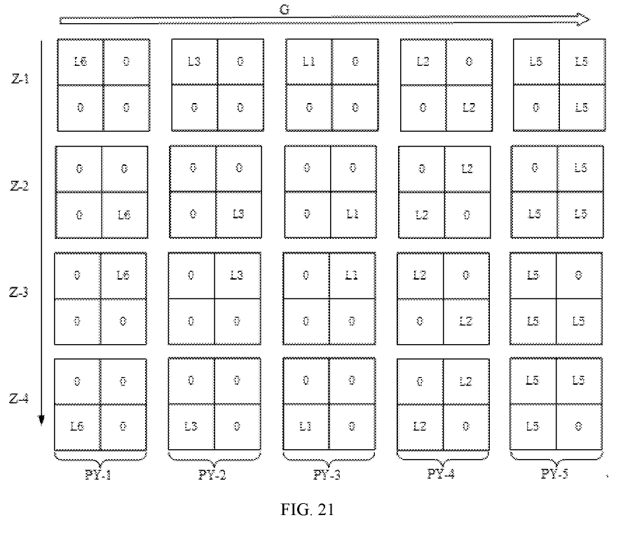

Taking FIG. 21 as an example, FIG. 21 is a schematic diagram of another pixel unit for displaying a rendering graphic according to an embodiment of the present disclosure. FIG. 21 illustrates that 5 pixel units PY in 4 frames (Z-1, Z-2, Z-3, Z-4) of continuous display respectively display rendering graphics with different grayscales. The 5 pixel units PY are respectively PY-1, PY-2, PY-3, PY-4 and PY-5, and the grayscales G displayed by the 5 pixel units PY from left to right gradually increase. The pixel unit PY-1 displays the brightness corresponding to the sixth grayscale G6, the number of actual light-emitting pixels is 1, and the brightness of the light-emitting pixel is L6. The pixel unit PY-2 displays the brightness corresponding to the third grayscale G3, the number of actual light-emitting pixels is 1, and the brightness of the light-emitting pixel is L3. The pixel unit PY-3 displays the brightness corresponding to the first grayscale G1, the number of actual light-emitting pixels is 1, and the brightness of the light-emitting pixel is L1. The pixel unit PY-4 displays the brightness corresponding to the second grayscale G2, the number of actual light-emitting pixels is 2, and the brightness of the light-emitting pixel is L2. The pixel unit PY-5 displays the brightness corresponding to the fifth grayscale G5, the number of actual light-emitting pixels is 3, and the brightness of the light-emitting pixel is L5. Where L6<L3<L1<L2<L5.

The pixel unit PY includes 4 pixels 40, and the pixel unit PY has 4 light-emitting modes. When the number of actual light-emitting pixels in the pixel unit PY is 1, 2 and 3, the pixel unit PY corresponds to 4 light-emitting modes respectively. As can be seen from FIG. 21, when the display panel continuously displays 4 frames (Z-1, Z-2, Z-3, Z-4), each of the pixel unit PY-1, the pixel unit PY-2, the pixel unit PY-3, the pixel unit PY-4, and the pixel unit PY-5 sequentially performs 4 light-emitting modes, and a same pixel unit has a same light-emitting brightness in each frame.

It should be noted that the four light-emitting modes M (1), M (2), M (3) and M (4) respectively illustrated in FIG. 18 to FIG. 20 do not limit the display sequence of the light-emitting modes when the pixel unit sequentially performs the four light-emitting modes during actual display.

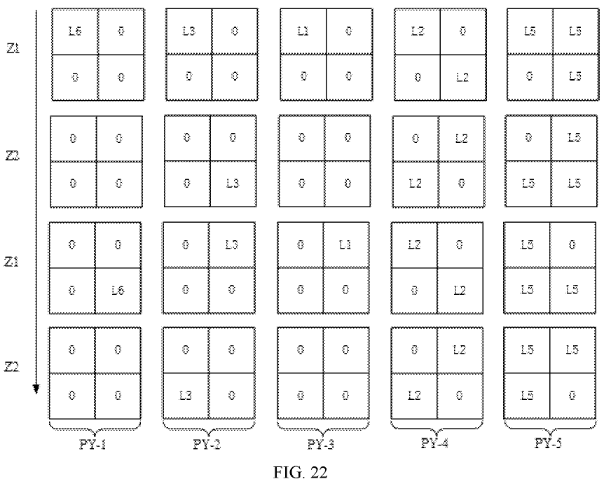

In some other embodiments, FIG. 22 is a schematic diagram of another pixel unit for displaying a rendering graphic according to an embodiment of the present disclosure. FIG. 22 illustrates that the display panel continuously displays rendering graphics with different grayscales of 5 pixel units PY in the first frame Z1 and the second frame Z2. The grayscales displayed by the pixel units PY-1, PY-2, PY-3, PY-4 and PY-5 in the first frame Z1 and the second frame Z2 are merely illustrative. In some embodiments of the present disclosure, the driving chip 20 drives the display panel 10 to continuously display the first frame Z1 and the second frame Z2. The pixel 40 in at least one pixel unit PY emits light in one of the first frame Z1 and the second frame Z2. As shown in FIG. 22, the pixel unit PY-1 and the pixel unit PY-3 emit light only in the first frame Z1 and do not emit light in the second frame Z2. In addition, when the pixel unit emits light in both the consecutively displayed first frame Z1 and second frame Z2, the display grayscales of the pixel unit in the consecutively displayed first frame Z1 and second frame Z2 may be same or different. In an embodiment of the present disclosure, at least one pixel unit PY is configured to emit light in one of two consecutively displayed frames, that is, the pixel unit PY does not emit light in the other one of the two consecutively displayed frames. By displaying one frame in a manner that at least one pixel unit PY in the display panel skips the grayscale, the contrast of the image displayed in this frame can be enhanced.

The display manner provided in the embodiment of FIG. 22 may be configured to display a static image, or may be configured to display a dynamic image. When the driving chip 20 receives a plurality of consecutive groups of same image data and drives the display panel 10 to display based on the plurality of consecutive groups of same image data, the display panel 10 displays the static image. When the driving chip 20 receives a plurality of consecutive groups of different image data and drives the display panel 10 to display based on the plurality of consecutive groups of different image data, the display panel 10 displays the dynamic image.

In some other embodiments, the driving chip 20 drives the display panel 10 to display a plurality of consecutive frames. The display panel 10 includes a second working mode. In the second working mode, the driving chip 20 receives a plurality of groups of same image data. The driving chip 20 driving the display panel 10 to work in the second working mode includes: for each of at least one pixel unit PY, the number of light-emitting pixels in the pixel unit PY in one of two adjacent frames is different from the number of light-emitting pixels in the pixel unit PY in the other one of the two adjacent frames, and the brightness of the light-emitting pixel 40 in the pixel unit PY in one of two adjacent frames is the same as the brightness of the light-emitting pixel 40 in the pixel unit PY in the other one of the two adjacent frames. The display panel 10 displays a static image in the second working mode. By using the solutions according to the embodiments of the present disclosure to drive the display panel 10 to work in the second working mode, it is possible to randomly configure at least one pixel unit PY such that the number of light-emitting pixels is different in two adjacent frames while the brightness of the light-emitting pixel 40 remains the same in two adjacent frames, thereby enhancing the image contrast and reducing the display granularity at the expense of flicker.

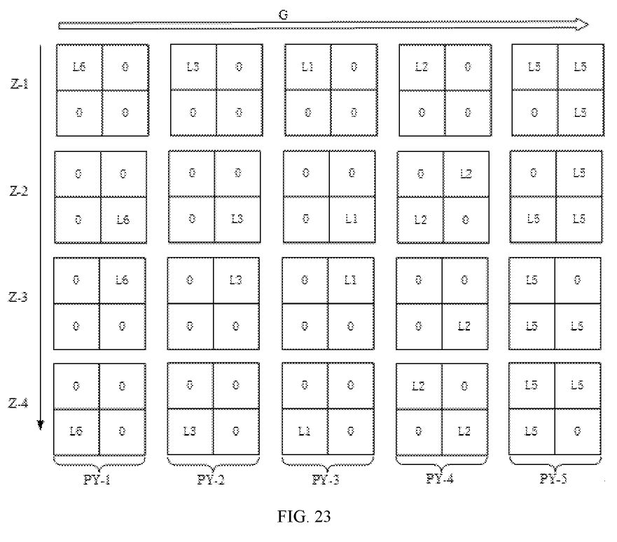

FIG. 23 is a schematic diagram of another pixel unit for displaying a rendering graphic according to an embodiment of the present disclosure. FIG. 23 illustrates rendering graphics of 5 pixel units PY in 4 consecutively displayed frames (Z-1, Z-2, Z-3, Z-4), where the 5 pixel units PY are respectively PY-1, PY-2, PY-3, PY-4, PY-5. The driving chip 20 drives the display panel to continuously display 4 frames (Z-1, Z-2, Z-3, Z-4) shown in FIG. 23 according to a plurality of groups of same image data that is received. It can be seen from FIG. 23 that number of light-emitting pixels is different in two adjacent frames, and the brightness of the light-emitting pixel is the same in two adjacent frames.

In some embodiments of the present disclosure, the pixel unit PY includes n pixels 40 with a same color.

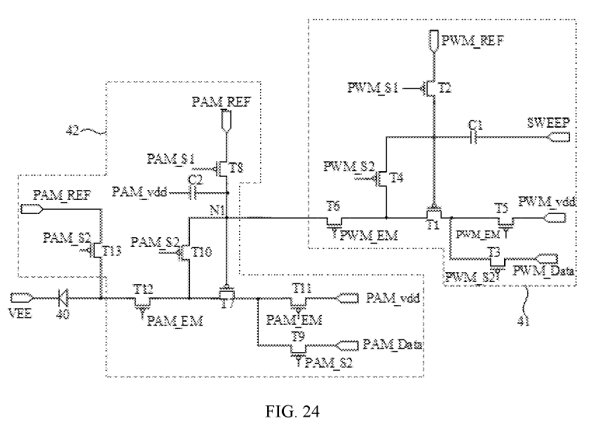

In an embodiment of the present disclosure, the display panel 10 includes a plurality of pixel circuits electrically connected to the pixels 40. FIG. 24 is a schematic diagram of a pixel circuit according to an embodiment of the present disclosure. As shown in FIG. 24, the pixel circuit includes a first driving circuit 41 and a second driving circuit 42. The first driving circuit 41 is configured to control a duration of providing a driving current to the pixel 40 based on a first data voltage PWM-data, and the second driving circuit 42 is configured to control an amplitude of providing the driving current to the pixel 40 based on a second data voltage PAM-data. The first driving circuit 001 is a pulse width modulation circuit, and the second driving circuit 002 is a pulse amplitude modulation circuit.

The first driving circuit 41 includes a first driving transistor T1, a first gate reset transistor T2, a first data writing transistor T3, a first compensation transistor T4, a first control transistor T6, a second control transistor T5, and a first capacitor C1. The first capacitor C1 is a storage capacitor in the first driving circuit 41. The second control transistor T5 is connected between a first power voltage PWM-vdd and a first electrode of the first driving transistor T1, and the first control transistor T6 is connected between a second electrode of the first driving transistor T1 and a first node N1. The first data writing transistor T3 is connected to the first electrode of the first driving transistor T1. The first compensation transistor T4 is connected to the second electrode of the first driving transistor T1 and a gate of the first driving transistor T1. The first gate reset transistor T2 is connected to the gate of the first driving transistor T1. A first electrode plate of the first capacitor C1 is connected to the gate of the first driving transistor T1, and a second electrode plate of the first capacitor C1 is connected to a sweep signal SWEEP. A gate of the first gate reset transistor T2 is connected to a scan signal PWM-S1. A gate of the first data writing transistor T3 and a gate of the first compensation transistor T4 each are connected to a scan signal PWM-S2. A gate of the first control transistor T6 and a gate of the second control transistor T5 each are connected to a first light-emitting control signal PWM-EM. The first gate reset transistor T2 receives a reset signal PWM-REF.

The second driving circuit 42 includes a second driving transistor T7, a second gate reset transistor T8, a second data writing transistor T9, a second compensation transistor T10, a third control transistor T11, a fourth control transistor T12, an electrode reset transistor T13, and a second capacitor C2. The third control transistor T11 is connected between the second power voltage PAM-vdd and a first electrode of the second driving transistor T7, and the fourth control transistor T12 is connected between a second electrode of the second driving transistor T7 and the pixel 40. The second driving transistor T7 is configured to generate a driving current under control of a gate voltage thereof, and a gate of the second driving transistor T7 is connected to the first node N1. The second data writing transistor T9 is connected to the first electrode of the second driving transistor T7, the second compensation transistor T10 is connected to the second electrode and the gate electrode of the second driving transistor T7, the second gate reset transistor T8 is connected to the gate electrode of the second driving transistor T7, the electrode reset transistor T13 is connected to the first electrode of the pixel 40, the fourth control transistor T12 is also connected to the first electrode of the pixel 40, and the second electrode of the pixel 40 is connected to a third power supply voltage VEE. A gate of the second gate reset transistor T8 is connected to a scan signal PAM-S1. A gate of the second data writing transistor T9, a gate of the second compensation transistor T10 and a gate of the electrode reset transistor T13 each are connected to a scan signal PAM-S2. A gate of the third control transistor T11 and a gate of the fourth control transistor T12 each are connected to a second light-emitting control signal PAM-EM. The second gate reset transistor T8 and the electrode reset transistor T13 receive a reset signal PAM-REF, respectively. In some other embodiments of the present disclosure, the electrode reset transistor T13 may also receive a constant voltage signal, and the constant voltage signal and the reset signal PAM-REF have different voltage values.

In some other embodiments, the display panel includes a pixel circuit electrically connected to the pixel 40. The pixel circuit includes a transistors T and b capacitors C, where a and b are both positive integers. For example, the pixel circuit has a 7T1C structure.

The above description merely illustrates some preferred embodiments of the present disclosure and is not intended to limit the present disclosure, and any modification, equivalent substitution, improvement and the like made within a spirit and a principle of the present disclosure shall fall with a scope of the present disclosure.

Finally, it should be noted that, the above-described embodiments are merely for illustrating the present disclosure but not intended to provide any limitation. Although the present disclosure has been described in detail with reference to the above-described embodiments, it should be understood by those skilled in the art that, it is still possible to modify the technical solutions described in the above embodiments or to equivalently replace some or all of the technical features therein, but these modifications or replacements do not cause the essence of corresponding technical solutions to depart from the scope of the present disclosure.

What is claimed is:

1. A display device, comprising a display panel and a driving chip, wherein the driving chip is electrically connected to the display panel; the display panel comprises a display region provided with a plurality of pixel units, one pixel unit of the plurality of pixel units comprises n pixels, where n is an integer and n≥2;
the driving chip drives the display panel to display according to grayscale information of the pixel unit in image data, a number of light-emitting pixels in the pixel unit during display is less than p, where p is an integer and 1≤p≤n, and p is a number of pixels with a non-zero grayscale in the grayscale information of the pixel unit, wherein
when grayscale information of the pixel unit in the image data is a first grayscale, a number of light-emitting pixels in the pixel unit of the display panel during display is n1, and a brightness of at least one pixel is L1, where n1 is an integer and 1≤n1<n;
when grayscale information of the pixel unit in the image data is a second grayscale, a number of light-emitting pixels in the pixel unit of the display panel during display is n2, and a brightness of at least one pixel is L2, where n2 is a positive integer and n2<n; and
wherein the first grayscale is smaller than the second grayscale, and n1<n2 and L1<L2.

2. The display device according to claim 1, wherein
the driving chip comprises a brightness allocation module and a display data module;
the brightness allocation module is configured to calculate a sum of brightness of n pixels in the pixel unit in the image data, and determine the number of light-emitting pixels in the pixel unit and an allocated grayscale of each pixel based on p and the sum of brightness; and
the display data module is configured to drive the display panel to display according to the number of light-emitting pixels in the pixel unit and the allocated grayscale, and the brightness of each pixel corresponds to the allocated grayscale.

3. The display device according to claim 2, wherein
the brightness allocation module comprises a searching sub-module and a data generation sub-module;
the searching sub-module is configured to calculate the sum of brightness, and search and determine the number of pixels in a table for a relationship between a brightness range and a number of pixels according to the sum of brightness; in the table for the relationship between the brightness range and the number of pixels, the number of pixels is positively correlated with a maximum threshold of the brightness range; and
the data generation sub-module is configured to determine the number of light-emitting pixels in the pixel unit according to the searched number of pixels, and calculate the allocated grayscale according to the number of light-emitting pixels and the sum of brightness.

4. The display device according to claim 1, wherein
when grayscale information of the pixel unit in the image data is a third grayscale, a number of light-emitting pixels in the pixel unit of the display panel during display is n3, and a brightness of at least one pixel is L3; and
wherein the third grayscale is smaller than the first grayscale, and n3=n1 and L3<L1.

5. The display device according to claim 4, wherein n1=1.

6. The display device according to claim 1, wherein
when the display panel displays, for at least one pixel unit, a number of light-emitting pixels in the pixel unit is more than one, and at least two light-emitting pixels in the pixel unit have different brightnesses.

7. The display device according to claim 6, wherein
n2≥2; and
grayscale information of the pixel unit in the image data is the second grayscale, and the pixel unit further comprises at least one pixel with a light-emitting brightness of L₂₁ when the display panel displays, where L₂₁1<L.

8. The display device according to claim 1, wherein
when the display panel displays, for at least one pixel unit, a number of light-emitting pixels in the pixel unit is larger than one, and the light-emitting pixels in the pixel unit have a same brightness.

9. The display device according to claim 8, wherein
when grayscale information of the pixel unit in the image data is a fourth grayscale, a number of light-emitting pixels in the pixel unit of the display panel during display is n4, and a brightness of at least one pixel is L4; and
the fourth grayscale is larger than the first grayscale and smaller than the second grayscale, and n4=n2 and L4<L1.

10. The display device according to claim 1, wherein
when grayscale information of the pixel unit in the image data is a fifth grayscale, a number of light-emitting pixels in the pixel unit of the display panel during display is n5, and a brightness of at least one pixel is L5; and
the second grayscale is smaller than the fifth grayscale, and n2<n5 and/or L2<L5.

11. The display device according to claim 10, wherein
grayscale information of the pixel unit in the image data is the second grayscale, and the light-emitting pixels in the pixel unit have a same brightness when the display panel displays; and
grayscale information of the pixel unit in the image data is the fifth grayscale, and the light-emitting pixels in the pixel unit have a same brightness when the display panel displays.

12. The display device according to claim 10, wherein n2-n1=1, and n5-n2=1.

13. The display device according to claim 1, wherein
the plurality of pixel unit comprises a first pixel unit and a second pixel unit;
the driving chip drives the first pixel unit to display according to the grayscale information of the first pixel unit in the image data, and drives the second pixel unit to display according to the grayscale information of the second pixel unit; and
wherein the grayscale information of the first pixel unit and the grayscale information of the second pixel unit in the image data are the same; when the display panel displays, a number of light-emitting pixels in the first pixel unit and a number of light-emitting pixels in the second pixel unit are the same, and a brightness of the pixel in the first pixel unit is the same as a brightness of the pixel in the second pixel unit.

14. The display device according to claim 1, wherein
the driving chip drives the display panel to display a plurality of consecutive frames; and
wherein for at least one pixel unit, at least one light-emitting pixel corresponds to different positions in two adjacent frames.

15. The display device according to claim 14, wherein
n=4, and
one pixel unit comprises two light-emitting pixels in one of two adjacent frames, the two light-emitting pixels are located at diagonal positions of the pixel unit, and the light-emitting pixels correspond to different positions in the two adjacent frames.

16. The display device according to claim 14, wherein
the pixel unit comprises n light-emitting modes; when the display panel displays, only one pixel in the pixel unit emits light, and the only one light-emitting pixel corresponds to different positions in the n light-emitting modes of the pixel unit; and
the driving chip driving the display panel to display a plurality of consecutive frames comprises: the pixel unit sequentially performing the n light-emitting modes in a plurality of consecutive frames.

17. The display device according to claim 14, wherein
the pixel unit comprises n light-emitting modes; when the display panel displays, only one pixel in the pixel unit emits light, and the only one light-emitting pixel corresponds to different positions in the n light-emitting modes of the pixel unit; and
the display panel comprises a first working mode, in which the driving chip receives a plurality of groups of same image data; and
the driving chip driving the display panel to work in the first working mode comprises: the pixel unit sequentially performing the n light-emitting modes in a plurality of consecutive frames.

18. The display device according to claim 1, wherein
the driving chip drives the display panel to continuously display a first frame and a second frame; and
wherein the pixels in one pixel unit emit light in one of the first frame or the second frame.

19. The display device according to claim 1, wherein
the driving chip drives the display panel to display a plurality of consecutive frames; and
the display panel comprises a second working mode, in which the driving chip receives a plurality of groups of same image data; and
the driving chip driving the display panel to work in the second working mode comprises: for at least one pixel unit, the number of light-emitting pixels in one of two adjacent frames is different from the number of light-emitting pixels in the other one of the two adjacent frames, and a brightness of the light-emitting pixel in one of two adjacent frames is the same as a brightness of the light-emitting pixel in the other one of the two adjacent frames.

20. The display device according to claim 1, wherein
the display panel comprises a plurality of pixel circuits electrically connected to the plurality of pixels; and
at least one of the plurality of pixel circuits comprises a first driving circuit and a second driving circuit, the first driving circuit is configured to control a duration of providing a driving current to the pixel based on a first data voltage, and the second driving circuit is configured to control an amplitude of providing a driving current to the pixel based on a second data voltage.
